(19) United States
(12) Patent Application Publication
(10) Pub. No.: US 2018/0176764 A1
(43) Pub. Date: Jun. 21, 2018

(54) MANAGEMENT DEVICE, ACCESS POINT AND INFORMATION COLLECTION METHOD

(71) Applicant: NEC Corporation, Minato-ku (JP)

(72) Inventor: Shigehiro MIYASHITA, Tokyo (JP)

(21) Appl. No.: 15/577,163

(22) PCT Filed: May 27, 2016
(86) PCT No.: PCT/JP2016/065723

§ 371 Date: Nov. 27, 2017

(30) Foreign Application Priority Data
May 28, 2015 (JP) 2015-108527

(51) Int. Cl. H04W 8/18; G06Q 30/02; H04W 48/10

(52) U.S. Cl. CPC H04W 8/18; H04W 88/08; H04W 48/10; G06Q 30/0277

(57) ABSTRACT

A communications system that facilitates installation of an access point includes an access point, an aggregation device, and a management device. The access point: broadcasts an identifier identifying each of multiple wireless networks; and outputs, as access information, access by a terminal using the identifier. The aggregation device stores the access information and generates an access log. The management device accepts an identifier character string transmitted by the access point, and alters the identifier on the basis of the inputted character string. The management device sends a request to the aggregation device to output user identifier information including the identifier used by the terminal connected to a wireless network. The aggregation device generates user identifier information from the access log, and outputs the generated information to the management device. The management device outputs information corresponding to the acquired user identifier information to the outside.

### CROSS-REFERENCE TO RELATED APPLICATIONS

The present invention is based on the Japanese Patent Application No. 2015-108527 filed on May 28, 2015, and the entirety of the contents of the application is incorporated herein by reference.

The present invention relates to a communication system, a management device, an access point, an information collection method, and a program. In particular, the present invention relates to a communication system, a management device, an access point, an information collection method, and a program supporting a wireless local area network (LAN).

### TECHNICAL FIELD

### Background Art

In recent years, there is a rapid increase in traffic that uses a circuit network such as 3rd Generation (3G)/Long Term Evolution (LTE), due to spread of wireless terminals including smartphones. Thus, telecommunications carriers promote expansion of facilities for realizing Internet connection by means of a wireless LAN, as well as mobile phone network facilities. Specifically, an access point (AP) is installed in a station, an airport, and the like, and wireless connection by means of the wireless LAN is provided to a user who has a contract with a telecommunications carrier. Alternatively, a retail shop such as a convenience store may install an access point in the shop, or an autonomy may install an access point in a communal facility in order to achieve regional revitalization.

PTL 1 describes that a mobile device (a wireless terminal) including an interface for accessing a circuit network such as LTE and an interface for accessing a wireless LAN is used (see paragraph [0002] and the like in PTL 1).

PTL 2 discloses a system that uses a public wireless LAN referred to as Passpoint (“Wi-Fi CERTIFIED PASSPOINT” a registered trademark). As described in PTL 2, user authentication is automatically performed upon entering a Wi-Fi area of a contracted wireless LAN service, and use of wireless connection is enabled.

### CITATION LIST

### Patent Literature

PTL 1: Japanese Translation of PCT International Application Publication No. JP-T-2015-502125

### PTL 2: Japanese Unexamined Patent Application Publication No. 2015-53582

### SUMMARY OF INVENTION

### Technical Problem

Note that each disclosure of the above Citation List is incorporated herein by reference. The following analysis is made by the present inventors.

As described above, a telecommunications carrier, a retail shop, and the like install an access point. In the case, a single access point may be shared by a plurality of companies. For example, referring to FIG. 17, an access point 11 is an access point installed in a retail shop, and is shared between a telecommunications carrier and a company running the retail shop.

The access point 11 supports a plurality of types of extended service set identifiers (ESSIDs; hereinafter, simply written as “SSIDs”). Specifically, the access point 11 supports SSID_1 for providing wireless connection to a user who has a contract with the telecommunications carrier in advance, and SSID_2 for providing wireless connection to a user who comes to the retail shop.

A user who visits the retail shop operates his or her own terminal and displays a wireless LAN setting screen (a Wi-Fi spot selection screen) on the terminal, and selects SSID_1 in the case of using a wireless LAN provided by the telecommunications carrier, or selects SSID_2 in the case of using a wireless LAN provided by the retail shop. For example, when a user who possesses a terminal 61-1 selects SSID_1, a packet for user authentication is transmitted from the access point 11 toward a management server 71. The management server 71 having received the packet authenticates whether or not the terminal 61-1 requesting for use of the wireless LAN with SSID_1 has a valid authority, and transfers a packet from the terminal 61-1 to the Internet when the terminal 61-1 has a valid authority.

Alternatively, when a user who possesses a terminal 61-2 selects SSID_2, the access point 11 performs control in such a way as to connect the terminal 61-2 to a web server 31. Before connecting the terminal 61-2 to the Internet, the web server 31 implements a portal site for collecting information relating to the user who uses the terminal 61-2 (for example, an email address, gender, and the like of the user) and for obtaining agreement with terms of use. The web server 31 transfers a packet from the terminal 61-2 to the Internet on condition of user's agreement with terms of use.

Note that an access point that is installed in a retail shop and the like is normally connected with an aggregation device 21 installed for every particular region. The aggregation device 21 sorts (relays) packets transmitted from the access point 11, and collects and stores, as an access log, information on a terminal connected to the access point 11 (an identifier of the terminal and the like). For example, the aggregation device 21 transmits a packet from the terminal 61-1 having selected SSID_1 toward the management server 71, and transmits a packet from the terminal 61-2 having selected SSID_2 toward the web server 31.

As described above by using FIG. 17, an access point may be installed in a retail shop and the like. However, there is a problem that the number of users of a wireless LAN provided by a retail shop does not grow as much as the retail shop expects. As described above, a user who attempts to use the wireless LAN provided by the retail shop is requested for user's own personal information, agreement with terms of use, and the like. It is conceivable that such information provision becomes an obstacle that prevents growth of the number of users of the wireless LAN provided by the retail shop and the like.

On the other hand, a retail shop expects to give an advertisement of a commodity on a portal site that is used in providing Internet connection to a user. In other words, a retail shop and the like regard a portal site in providing Internet connection to a user as one of sales promotion means. If wireless LAN connection of the own retail shop and the like is not used, necessity for installing an access point decreases. This is similar for an access point installed by an autonomy. It is conceivable that requesting more advance preparation for using the access point installed by the autonomy reduces the use rate. As a result, the autonomy is less motivated to install an access point.

However, an access point of a wireless LAN has an aspect as a telecommunications infrastructure that ensures a communication means in case of disaster and the like. It is problematic in terms of public interests as well that installation of an access point is not promoted.

In light of the above situation, an object of the present invention is to provide a communication system, a management device, an access point, an information collection method, and a program that contribute to facilitating installation of an access point.

### Solution to Problem

According to a first aspect of the present invention, a communication system is provided. The communication system includes:

an access point that broadcasts at least two or more identifiers for identifying at least two or more respective wireless networks, and outputs, as access information, an access by a terminal using the identifier;

an aggregation device that stores the access information output by the access point, and generates an access log; and

a management device that receives data of a character string of the identifier to be broadcasted by the access point, and alters, based on the character string, the identifier to be broadcasted by the access point.

The management device requests the aggregation device to output user identifier information that includes the identifier used by the terminal connected to a wireless network formed by the access point. The aggregation device generates the user identifier information from the access log, and outputs the user identifier information to the management device. The management device outputs, to outside, information corresponding to the acquired user identifier information.

According to a second aspect of the present invention, a management device is provided. The management device is connected with:

an access point that broadcasts at least two or more identifiers for identifying at least two or more respective wireless networks, and outputs, as access information, an access by a terminal using the identifier, and

an aggregation device that stores the access information output by the access point, and generates an access log.

Further, the management device:

receives data of a character string of the identifier to be broadcasted by the access point, and altering, based on the character string, the identifier to be broadcasted by the access point,

requests the aggregation device to output user identifier information that includes the identifier used by the terminal connected to a wireless network formed by the access point, and

acquires the user identifier information generated by the aggregation device from the access log, and outputting, to outside, information corresponding to the acquired user identifier information.

According to a third aspect of the present invention, an access point is provided. The access point broadcasts at least two or more identifiers for identifying at least two or more respective wireless networks, and generates, as access information, an access by a terminal using the identifier, and includes:

means for storing the generated access information, and generating an access log;

means for receiving data of a character string of the identifier to be broadcasted, and altering, based on the character string, the identifier to be broadcasted; and

means for generating user identifier information that includes the identifier used by the terminal connected to a wireless network formed by the access point, and outputting the user identifier information to outside.

According to a fourth aspect of the present invention, an information collection method in a communication system is provided. The communication system includes: an access point that broadcasts at least two or more identifiers for identifying at least two or more respective wireless networks, and outputs, as access information, an access by a terminal using the identifier; an aggregation device that stores the access information output by the access point, and generates an access log; and a management device that receives data of a character string of the identifier to be broadcasted by the access point, and alters, based on the character string, the identifier to be broadcasted by the access point. The information collection method includes the steps of: requesting, by the management device, the aggregation device to output user identifier information that includes the identifier used by the terminal connected to a wireless network formed by the access point; generating, by the aggregation device, the user identifier information from the access log, and outputting the user identifier information to the management device; and

outputting, to outside, by the management device, information corresponding to the acquired user identifier information.

According to a fifth aspect of the present invention, a program is provided. The program causes a computer controlling a management device that is connected with

an access point that broadcasts at least two or more identifiers for identifying at least two or more respective wireless networks, and outputs, as access information, an access by a terminal using the identifier, and

an aggregation device that stores the access information output by the access point, and generates an access log,

to execute processing of:

receiving data of a character string of the identifier to be broadcasted by the access point, and altering, based on the character string, the identifier to be broadcasted by the access point;

requesting the aggregation device to output user identifier information that includes the identifier used by the terminal connected to a wireless network formed by the access point; and

acquiring the user identifier information generated by the aggregation device from the access log, and outputting, to outside, information corresponding to the acquired user identifier information.

Note that this program can be recorded on a computer-readable storage medium. The storage medium can be a non-transient storage medium such as a semiconductor memory, a hard disk, a magnetic recording medium, and an optical recording medium. The present invention can be also embodied as a computer program product.

### Advantageous Effects of Invention

According to the aspects of the present invention, provided are a communication system, a management device, an access point, an information collection method, and a program that contribute to facilitating installation of an access point.

### BRIEF DESCRIPTION OF DRAWINGS

FIG. 1 is a diagram for describing an outline of one example embodiment;

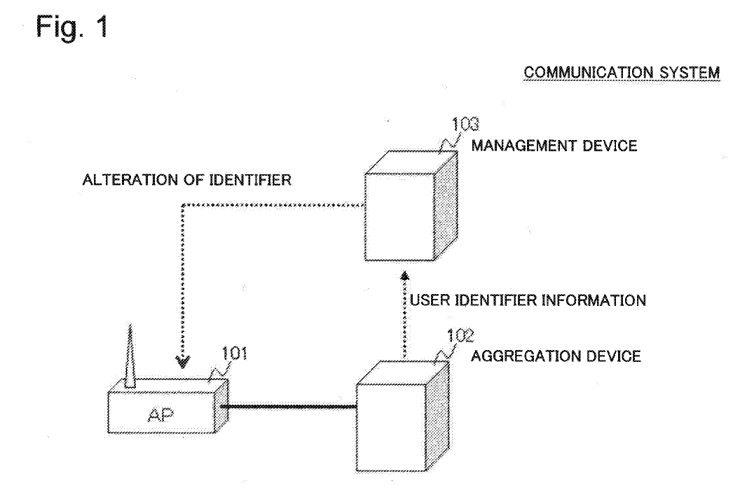

FIG. 2 is a diagram illustrating an example of a schematic configuration of a communication system according to a first example embodiment;

FIG. 3 is a diagram illustrating an example of an internal configuration of an access point according to the first example embodiment;

FIG. 4 is a diagram illustrating an example of an internal configuration of an aggregation device according to the first example embodiment;

FIG. 5 is a diagram illustrating an example of an access log management table;

FIG. 6 is a diagram illustrating an example of an internal configuration of a management device according to the first example embodiment;

FIG. 7 is a diagram illustrating an example of an SSID setting alteration screen displayed on a management terminal;

FIG. 8 is a sequence diagram illustrating an example of an operation of the communication system according to the first example embodiment;

FIG. 9 is a diagram illustrating an example of a Wi-Fi spot selection screen displayed on a terminal;

FIG. 10 is a diagram illustrating an example of an internal configuration of a management device according to a second example embodiment;

FIG. 11 is a diagram illustrating an example of a questionnaire result according to the second example embodiment;

FIG. 12 is a diagram illustrating an example of a graph of the number of wireless LAN connections according to the second example embodiment;

FIG. 13 is a diagram illustrating an example of an internal configuration of a management device according to a third example embodiment;

FIG. 14 is a diagram illustrating an example of a schematic configuration of a communication system according to a fourth example embodiment;

FIG. 15 is a diagram illustrating an example of an internal configuration of an access point according to the fourth example embodiment;

FIG. 16 is a diagram illustrating an example of a Wi-Fi spot selection screen displayed on a terminal; and

FIG. 17 is a diagram illustrating an example of a configuration of a communication system.

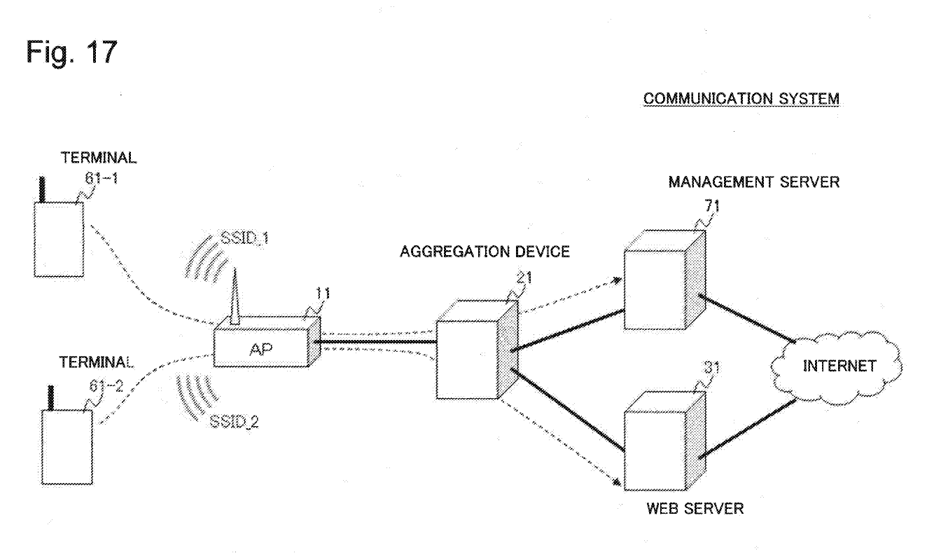

### DESCRIPTION OF EMBODIMENTS

First, an outline of one example embodiment will be described. Note that drawing reference signs appended in this outline are appended to elements for convenience as an example for assisting understanding, and description of this outline does not intend any limitation.

A communication system according to one example embodiment includes an access point 101, and requests for output of user identifier information that includes an identifier used by a terminal connected to a wireless network by an aggregation device. An aggregation device 102 generates user identifier information from an access log, and outputs the user identifier information to a management device 103. The management device 103 outputs, to outside, information corresponding to the acquired user identifier information.

An identifier (specifically, an ESSID) to be transmitted by the access point 101 is configured to be able to be altered from the management device 103. In other words, a character string of an identifier to be broadcasted from the access point 101 can be altered into an arbitrary character string by an owner of a retail shop and the like. Thus, the owner of the retail shop is able to perform such an operation as to set options for information that the owner of the retail shop wants to know in the character string of the identifier, and acquire, from the management device 103 and the aggregation device 102, information (user identifier information) relating to an option (an identifier) selected by a user. In this way, the owner of the retail shop is able to carry out a simple questionnaire (information collection) using the access point 101. As a result, the owner of the retail shop is able to carry out a questionnaire for the purpose of collecting information that seems to be beneficial to management of the retail shop, and is motivated to actively introduce (install) the access point 101 that enables configuration of such a questionnaire system.

Specific example embodiments will be described below in further detail with reference to the drawings. Note that the same components are assigned with the same signs throughout the respective example embodiments, and description therefor will be omitted.

### First Example Embodiment

A first example embodiment will be described in further detail by using the drawings.

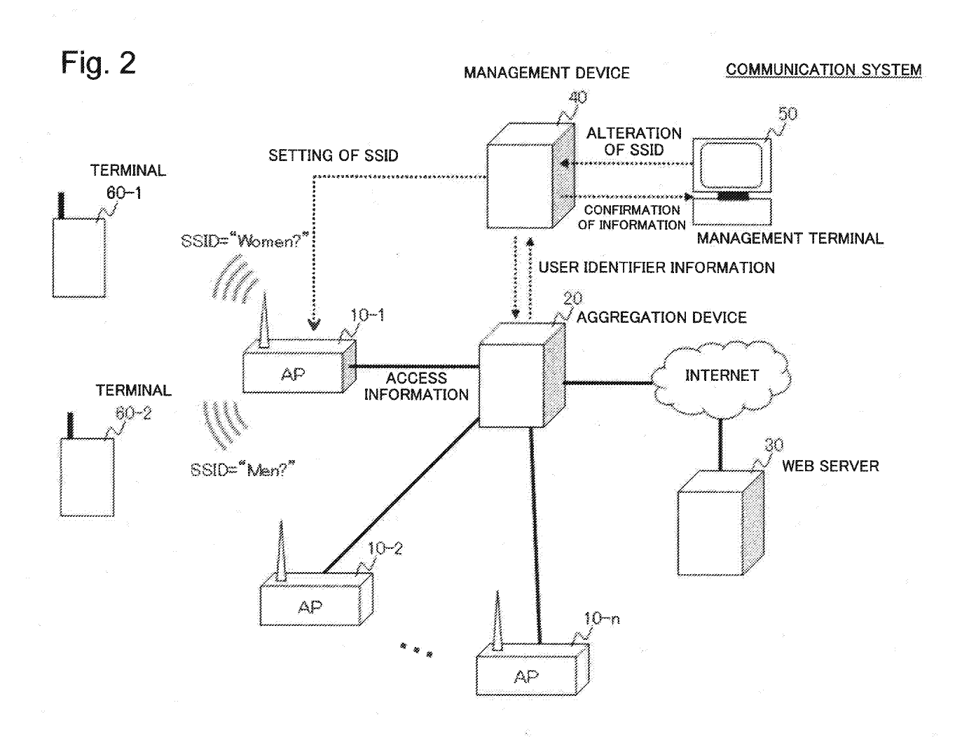

FIG. 2 is a diagram illustrating an example of a schematic configuration of a communication system according to the first example embodiment. Referring to FIG. 2, the communication system is configured by including a plurality of access points 10-1 to 10-n (where n is a positive integer; the same shall apply hereinafter.), an aggregation device 20, a web server 30, a management device 40, and a management terminal 50. Note that, in the following description, the access points 10-1 to 10-n will be simply written as “access points 10” in the absence of special reasons for distinguishing the access points 10-1 to 10-n.

[System Configuration Outline]

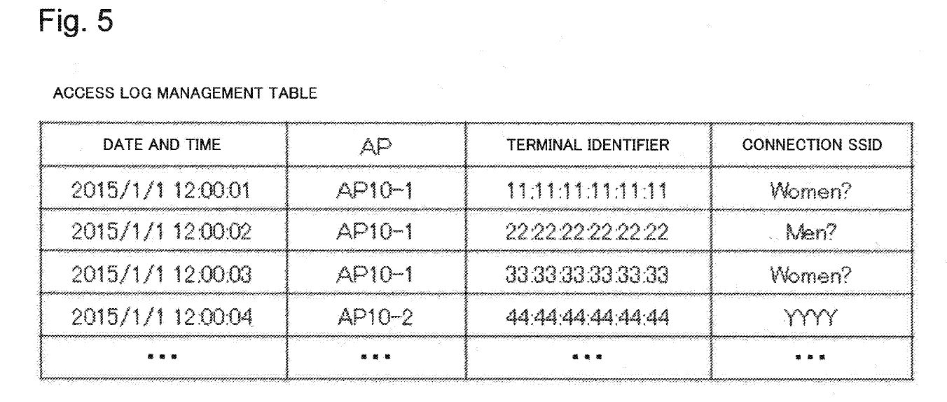

The access points 10 are wireless network devices in conformity with the Institute of Electrical and Electronics Engineers, Inc. (IEEE) 802.11. The access points 10 are wireless network relay devices supporting multi-SSID, and are configured such that each SSID can be altered. In other words, each of the access points 10 broadcasts an alterable identifier (an SSID, more precisely, an ESSID) for identifying each of at least two or more wireless networks. Note that each access point 10 outputs, as access information, a record of access by a terminal using an SSID to the aggregation device 20. Herein, as will be described later by using FIG. 5, the access information includes at least a terminal identifier and a connection SSID.

The aggregation device 20 is a device connected with the plurality of access points 10, and is a device that relays communication between each access point 10 and a server (not illustrated) on the Internet and the like. The aggregation device 20 is also a device that stores information on access by a terminal using the access point 10, and generates and manages an access log. The aggregation device 20 generates, in response to a request from the management device 40, user identifier information that includes information relating to an SSID used by the terminal connected to a wireless network by using the access point 10, and outputs the user identifier information to the management device 40.

The web server 30 is a server that provides a website. The web server 30 implements, for example, a portal site for obtaining agreement with terms of use when a retail shop provides a user with Internet connection, and for giving an advertisement to the user.

The management device 40 is a device that manages and controls the access points 10 and the aggregation device 20. The management device 40 has a function of receiving data of a character string of an SSID to be broadcasted by the access point 10 from an external terminal (the management terminal 50), and altering, based on the character string, an identifier to be broadcasted by the access point 10. The management device 40 also has a function of requesting the aggregation device 20 to output user identifier information, and outputting, to outside, information corresponding to the user identifier information acquired from the aggregation device 20.

The management terminal 50 is, for example, a device for altering an SSID to be transmitted from the access point 10 by an owner or a person in charge of a retail shop in which the access point 10 is installed. In other words, a user (an owner of a retail shop and the like) inputs, to the management device 40, a character string of an SSID to be transmitted from the access point 10 by operating the management terminal 50. The management device 40 receives an input of the character string from an external terminal (the management terminal 50), and alters, based on the character string, an identifier to be broadcasted by the access point 10. The management terminal 50 is also a device for confirming user identifier information to be obtained from the aggregation device 20 or information generated based on the user identifier information.

Terminals 60-1 and 60-2 are wireless terminals such as smartphones supporting wireless connection provided by a wireless LAN (a public wireless LAN).

Note that another access point, illustration of which is omitted in FIG. 2, is also a target of management by the management device 40 as well as the access point 10-1.

[Configuration of Access Point]

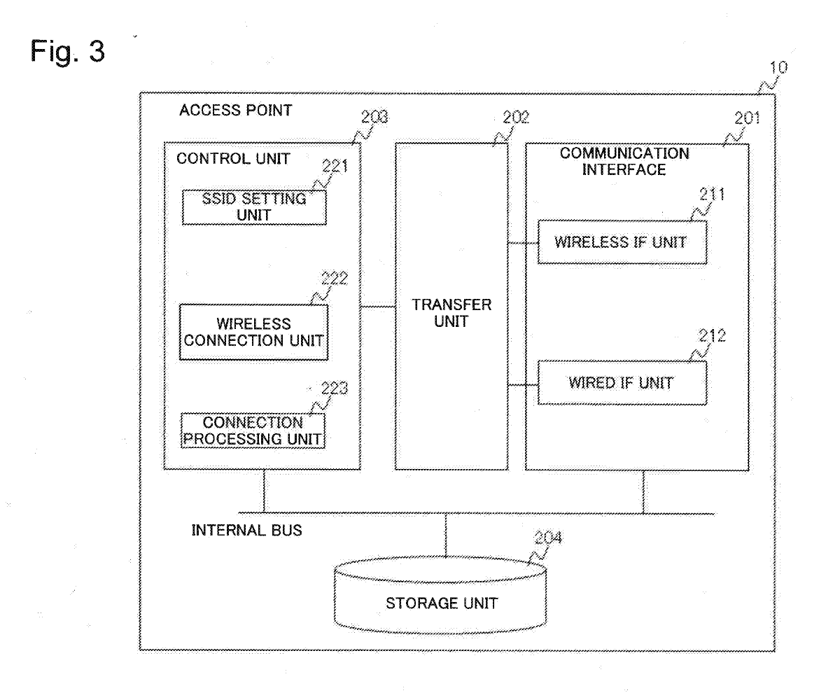

FIG. 3 is a diagram illustrating an example of an internal configuration of the access point 10. Referring to FIG. 3, the access point 10 is configured by including a communication interface 201, a transfer unit 202, a control unit 203, and a storage unit 204. Note that the units configuring the access point 10 are connected through an internal bus, and are configured in a mutually communicable manner (in a manner capable of transmitting and receiving data).

The communication interface 201 is a means that provides an interface between the access point 10 and another device (a wireless terminal, the aggregation device 20, and the management device 40). The communication interface 201 includes a wireless interface (IF) unit 211 and a wired interface unit 212.

The wireless interface unit 211 is a means that demodulates a radio wave received via an antenna (not illustrated), generates reception data, and generates a radio wave to be transmitted via the antenna. The wireless interface unit 211 passes the reception data to the transfer unit 202. In addition, the wireless interface unit 211 acquires transmission data from the control unit 203 and the wired interface unit 212 via the transfer unit 202.

The wireless interface unit 211 is capable of forming a wireless network by using two SSIDs, and has a function of broadcasting a beacon frame in which each SSID is set at a predetermined interval. A terminal having received the beacon frame transmitted from the wireless interface unit 211 selects, through a user operation, an SSID for using a wireless network, and transmits a frame including the selected SSID to the access point 10. The wireless interface unit 211 receives and passes the frame to the control unit 203.

Note that, in the first example embodiment, it is assumed that the access point 10 forms a wireless network by using two SSIDs, but it is not intended to limit the number of SSIDs supported by the access point 10 to two. The access point 10 may support three or more SSIDs.

The wired interface unit 212 is a means that realizes wired connection between the access point 10 and another device. For example, the wired interface unit 212 intermediates line connection between the access point 10 and the aggregation device 20. Alternatively, when the access point 10 and the management device 40 are wired-connected via a dedicated line or the Internet, the wired interface unit 212 serves as an interface for the management device 40. Note that, when the access point 10 and the management device 40 are wireless-connected, the wireless interface unit 211 serves as an interface for the management device 40.

The communication interface 201 passes data (for example, an SSID setting alteration instruction to be described later) acquired from the management device 40 to the control unit 203.

The transfer unit 202 is a means that achieves transfer of data (a packet) acquired from the communication interface 201. For example, when a packet acquired from the wireless interface unit 211 is a packet directed to a server on the Internet and the like, the transfer unit 202 transfers the packet to the wired interface unit 212. Alternatively, when a packet acquired from the wired interface unit 212 is a packet directed to a terminal under control of the access point 10, the transfer unit 202 transfers the packet to the wireless interface unit 211. Alternatively, when an acquired packet is a packet directed to the own device (the access point 10), the transfer unit 202 transfers the packet to the control unit 203.

The control unit 203 controls the entire access point 10. In addition, the control unit 203 includes a means (an SSID setting unit 221) that sets an SSID to be broadcasted from the wireless interface unit 211 in the wireless interface unit 211. When receiving an instruction pertaining to SSID setting alteration (an SSID setting alteration instruction) from the management device 40, the SSID setting unit 221 alters a content (a character string) of the SSID to be broadcasted from the wireless interface unit 211.

The control unit 203 includes a wireless connection unit 222 that performs control (for example, authentication and association of a terminal) for allocating an internet protocol (IP) address to a terminal to be contained in a wireless network formed by the access point 10, and for allowing the terminal to be contained in a wireless network of a selected SSID.

The control unit 203 also includes a connection processing unit 223 that performs processing for providing Internet connection to a terminal contained in a wireless network formed by the access point 10. Specifically, the connection processing unit 223 transmits, as access information, data that include a connection SSID selected by a terminal and information for identifying the terminal (a terminal identifier; for example, a media access control (MAC) address of a terminal) to the aggregation device 20.

In addition, the connection processing unit 223 generates information (for example, a uniform resource locator (URL) of the web server 30) for causing a web browser of a terminal contained in a wireless network to display a screen pertaining to a portal site provided by the web server 30, and transmits the information to the terminal.

The storage unit 204 is a means that stores data and the like necessary for the control unit 203 and the like to operate.

[Configuration of Aggregation Device]

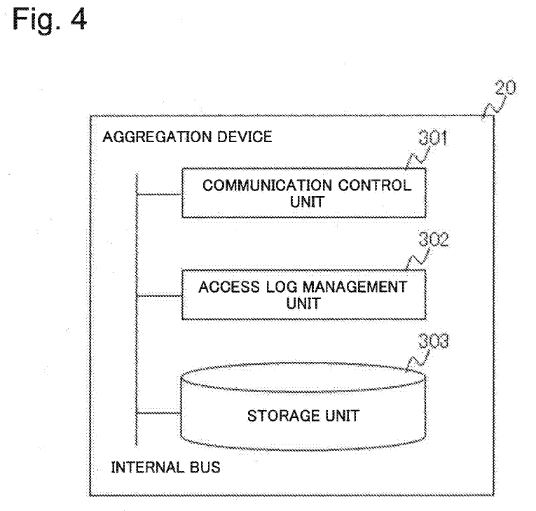

FIG. 4 is a diagram illustrating an example of an internal configuration of the aggregation device 20. Referring to FIG. 4, the aggregation device 20 is configured by including a communication control unit 301, an access log management unit 302, and a storage unit 303. Note that the units configuring the aggregation device 20 are connected through an internal bus and are mutually communicable.

The communication control unit 301 is a means that controls communication between the aggregation device 20 and another device (the access point 10, a device such as a router on the Internet, and the management device 40). Specifically, the communication control unit 301 includes an interface on a line side connecting between the access point 10 and the aggregation device 20, an interface on a line side connecting between the aggregation device 20 and the Internet, and an interface between the aggregation device 20 and the management device 40, respectively.

The access log management unit 302 is a means that stores access information transmitted by the connection processing unit 223 of the access point 10 in chronological order, and generates and manages an access log. Specifically, every time receiving access information from the access point 10, the access log management unit 302 adds an entry to an access log management table constructed in the storage unit 303.

FIG. 5 is a diagram illustrating an example of the access log management table constructed in the storage unit 303. Referring to FIG. 5, the access log management table includes fields relating to at least a date and time on which access information is acquired, identification information of the access point 10 that is a transmission source of the access information, and a terminal identifier and a connection SSID extracted from the access information. Note that the access log management unit 302 treats, for example, a date and time on which a packet pertaining to access information is acquired from the access point 10 as the date and time to be registered on the access log management table, and treats an address (an IP address and a MAC address) of the access point 10 included in the packet pertaining to the access information as the identification information to be registered on the access log management table.

Note that the access information to be transmitted from the access point 10 to the aggregation device 20 may include not only the terminal identifier and the connection SSID, but also a date and time on which the access point 10 allows a terminal to be contained in a wireless network, and an own identifier (an IP address and the like) of the access point 10. In this case, the aggregation device 20 is able to construct the access log management table illustrated in FIG. 5 by storing the acquired access information in chronological order.

Referring to FIG. 5, it can be seen that access using an SSID of “Women?” occurs to the access point 10-1 from two different terminals on Jan. 1, 2015. Similarly, it can be seen that access using an SSID of “Men?” occurs to the access point 10-1 on Jan. 1, 2015.

Upon receiving a request pertaining to output of user identifier information (hereinafter, written as a user identifier information output request) from the management device 40, the access log management unit 302 extracts necessary information (access information) and provides the information (outputs the user identifier information) to the management device 40.

Specifically, the management device 40 requests for output of user identifier information by designating a condition under which the aggregation device 20 generates the user identifier information. More specifically, the management device 40 requests for output of user identifier information by designating the access point 10 and a range relating to a date and time to be included in the user identifier information. For example, when receiving, from the management device 40, a request for output of user identifier information designating Jan. 1, 2015 as a date and time to be included in the user identifier information and relating to the access point 10-1, the access log management unit 302 extracts access information matching the condition (access information from first to third lines illustrated in FIG. 5) from the access log management table, and outputs, as the user identifier information, the extracted data to the management device 40.

[Configuration of Management Device]

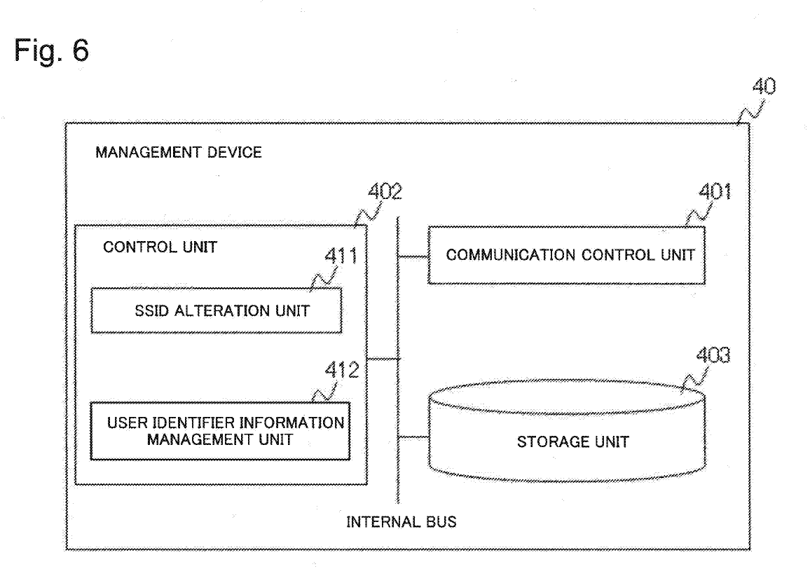

FIG. 6 is a diagram illustrating an example of an internal configuration of the management device 40. Referring to FIG. 6, the management device 40 is configured by including a communication control unit 401, a control unit 402, and a storage unit 403. Note that the units configuring the management device 40 are connected through an internal bus and are mutually communicable.

The communication control unit 401 is a means that controls communication between the access point 10, the aggregation device 20, and the management terminal 50. The communication control unit 401 passes data acquired from the management terminal 50 and the like to the control unit 402.

The control unit 402 includes an SSID alteration unit 411 and a user identifier information management unit 412.

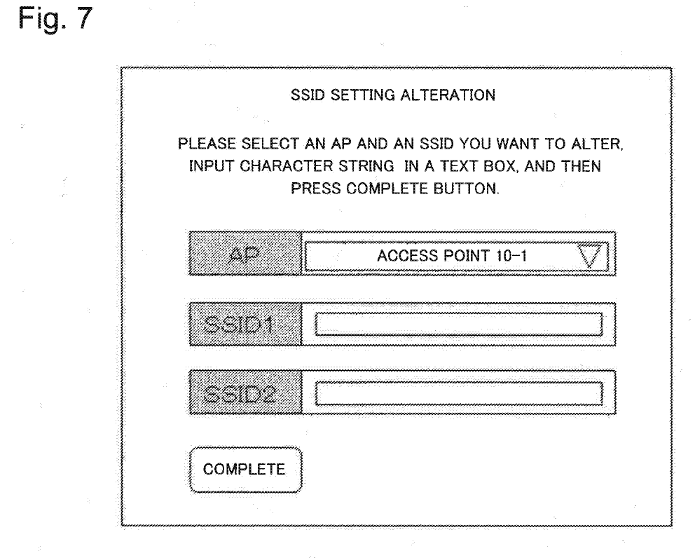

Upon receiving a request pertaining to SSID setting alteration from the management terminal 50, the SSID alteration unit 411 generates screen data for altering an SSID, and outputs the screen data to the management terminal 50. For example, the SSID alteration unit 411 generates screen data as illustrated in FIG. 7, and outputs the screen data to the management terminal 50. A user operates the management terminal 50, and selects the access point 10 for which the user wants to alter an SSID to be broadcasted. Simultaneously, the user inputs, to the management device 40, a character string of the SSID to be broadcasted from the selected access point 10. Note that the character string within a range of at most 32 alphanumeric characters (16 characters in the case of Japanese characters and the like) can be set as an SSID.

The SSID alteration unit 411 having acquired data (a character string of an SSID) input through the screen as illustrated in FIG. 7 transmits an SSID setting alteration instruction that includes the input data (a character string pertaining to the altered SSID) toward the selected access point 10. In other words, the SSID alteration unit 411 receives data of a character string of an SSID to be broadcasted by the access point 10 from the management terminal 50 that is an external terminal, and alters, based on the character string, the SSID to be broadcasted by the access point 10.

The user identifier information management unit 412 receives information (inputs a user identifier information output instruction) relating to which access log matching what condition is to be output as user identifier information, among access logs accumulated in the aggregation device 20 from the management terminal 50 (from an administrator of the access point 10 and the like). At the time, a specific date and time and the access point 10 to be included in the user identifier information are designated from the management terminal 50. The user identifier information management unit 412 requests the aggregation device 20 to output the user identifier information while providing the aggregation device 20 with the designated range as a condition under which the aggregation device 20 generates the user identifier information. In addition, upon acquiring a response to the user identifier information output request from the aggregation device 20, the user identifier information management unit 412 outputs the response to the management terminal 50.

The storage unit 403 is a means that stores data and the like necessary for the control unit 402 and the like to operate.

[System Operation]

Next, an operation of the communication system according to the first example embodiment will be described with reference to the drawings. Note that, in the first example embodiment, a case will be described in which the access point 10-1 is installed in a retail shop, and a character string of an SSID to be broadcasted from the access point 10-1 is altered by an owner (or a person in charge) of the retail shop.

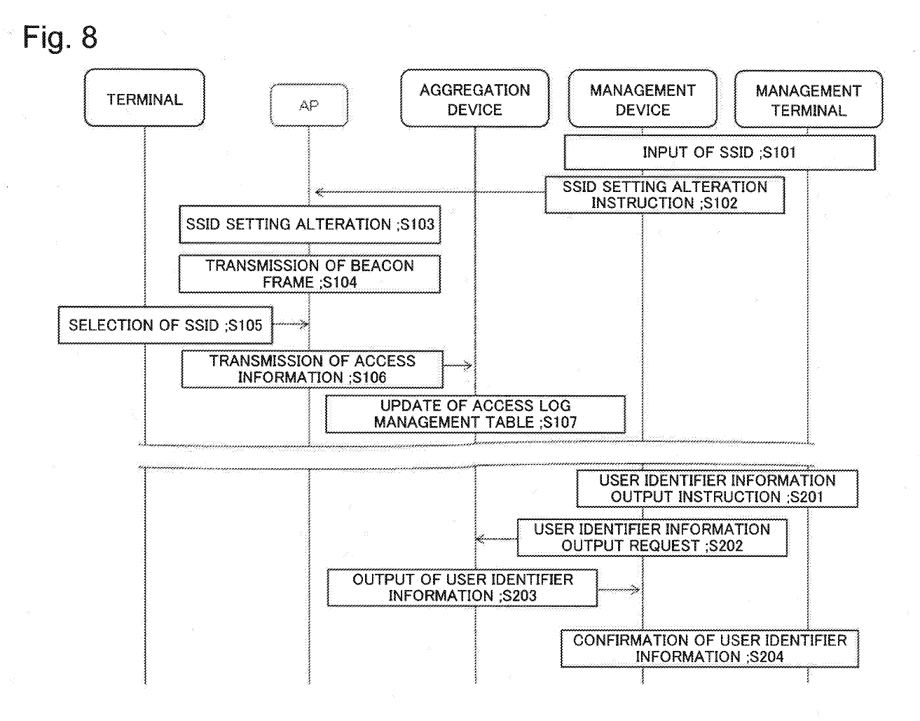

FIG. 8 is a sequence diagram illustrating an example of the operation of the communication system according to the first example embodiment. First, an owner of a retail shop in which the access point 10-1 is installed inputs, for the management device 40, a character string of an SSID to be transmitted from the access point 10-1, by using the management terminal 50 (Step S101).

For example, when the owner of the retail shop wants to know information relating to gender of a customer who visits the own retail shop, the owner of the retail shop sets “Women?” as one SSID of two SSIDs that can be set in the access point 10-1. Further, the owner sets “Men?” as another SSID. Note that it is desirably notified or the like by the owner of the retail shop that Internet connection by means of a wireless LAN is possible, and that names of access points in a questionnaire form are displayed in selection of an access point, from which a name of an access point concerned needs to be selected. Alternatively, when the number of characters permits, the owner may input character strings such as “Questionnaire; Women?” and “Questionnaire; Men?” in such a way as to clearly indicate that a questionnaire using SSIDs is executed, and may notify a user of the execution of the questionnaire using these SSIDs.

The management device 40 reflects setting alteration of the SSID from the management terminal 50 on the access point 10-1. Specifically, the management device 40 instructs the access point 10-1 to alter the SSID into the character string input by the owner at Step S101 (an SSID setting alteration instruction; Step S102).

The SSID setting unit 221 of the access point 10-1 sets, in the wireless interface unit 211, a character string pertaining to “Women?” and “Men?” as an SSID to be broadcasted, based on the SSID setting alteration instruction (Step S103).

Thereafter, the access point 10-1 periodically broadcasts a beacon frame that includes an SSID consisting of the character string “Women?” and an SSID consisting of the character string “Men?” (Step S104).

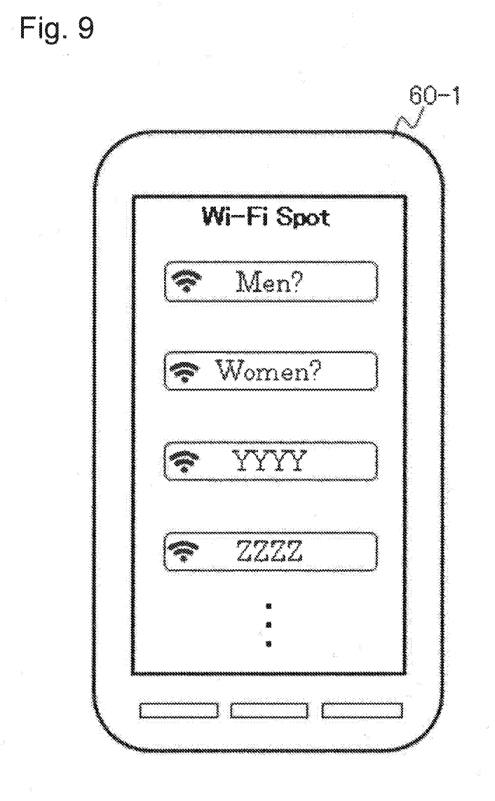

Under such a situation, for example, when a user who possesses the terminal 60-1 desires Internet connection of the terminal 60-1, the user operates the terminal 60-1 and displays a Wi-Fi spot selection screen (a screen for selecting an access point of a public wireless LAN). Specifically, a screen as illustrated in FIG. 9 is displayed on the terminal 60-1. Note that, out of four connection points (more precisely, SSIDs transmitted by access points) illustrated in FIG. 9, the upper two connection points are the two SSIDs transmitted by the access point 10-1. In addition, out of the four connection points illustrated in FIG. 9, the lower two connection points are SSIDs transmitted by an access point (not illustrated) provided by a telecommunications carrier.

Herein, in the first example embodiment, it is premised that a female user chooses “Women?” and a male user chooses “Men?” for the SSIDs “Women?” and “Men?” (options in the questionnaire). In other words, a male user is assumed to select the uppermost connection point (the connection point whose SSID is “Men?”) out of the four connection points illustrated in FIG. 9. Note that, when a terminal supports touch panel operation, the user selects an SSID by touching a display area of the SSID. Alternatively, the user operates a hardware key (a cross key, a selection key, and the like) provided on a main body and the like, and selects a desired SSID.

The terminal 60-1 having received an operation of the user transmits a frame that includes the selected SSID (the SSID pertaining to “Men?” in the above example) to the access point 10-1 (selection of an SSID; Step S105). Note that a user who does not intend to answer the questionnaire using the SSIDs selects an access point (either of the lower two access points in FIG. 9) provided by the telecommunications carrier, or gives up connection to a wireless LAN.

Upon receiving the frame described above, the access point 10-1 allocates an IP address to the terminal 60-1, and contains the terminal 60-1 in a wireless network whose SSID is “Men?”. In addition, the access point 10-1 transmits access information relating to the terminal 60-1 to the aggregation device 20 (Step S106)

The aggregation device 20 reflects the access information acquired from the access point 10-1 on an access log management table (update of an access log management table; Step S107).

The owner of the retail shop operates the management terminal 50, and issues an instruction for outputting user identifier information of the access point 10-1 to the management device 40 (Step S201).

The management device 40 having received the instruction issues an output request for user identifier information to the aggregation device 20 by designating a condition to be included in the user identifier information (Step S202).

The aggregation device 20 having received the output request extracts, based on an instruction, necessary access information from access logs, and transmits a result thereof (user identifier information) to the management device 40 (Step S203).

The management device 40 outputs the acquired user identifier information to the management terminal 50. The owner of the retail shop operates the management terminal 50 and confirms the user identifier information (Step S204).

In this way, the owner of the retail shop in which the access point 10-1 is installed is able to obtain what the owner wants to know (for example, information relating to gender of a customer who visits the retail shop), by analyzing information (user identifier information) that is obtained from the aggregation device 20.

As described above, in the communication system according to the first example embodiment, each access point 10 outputs, to the aggregation device 20, access information that includes an SSID to be used when containing a terminal in a wireless network formed by the own device. The aggregation device 20 accumulates the access information output by each access point 10, and generates an access log relating to network connection of a terminal using the access point 10. The management device 40 requests the aggregation device 20 to output user identifier information for confirming what SSID is used, and provides a result thereof to an owner of a retail shop via the management terminal 50.

Herein, in the communication system according to the first example embodiment, a character string of an SSID to be broadcasted from the access point 10 can be altered into an arbitrary character string by the owner of the retail shop. Thus, a simple questionnaire can be carried out, by setting an option for information that the owner of the retail shop wants to know in a character string of an SSID, and acquiring a result of use of the SSID (user identifier information) from the aggregation device 20 and the management device 40. As a result, the owner of the retail shop is able to obtain information that seems to be beneficial to management of the retail shop, and may be motivated to actively introduce an access point that enables provision of the questionnaire system described above. In other words, installation of an access point is facilitated.

In addition, in the communication system (simple questionnaire system) according to the first example embodiment, no personal information (for example, an email address and the like) of a user is required in providing Internet connection to the user. In other words, the user can connect to the Internet merely by answering a simple questionnaire, and it is conceivable that there is less feeling of hesitation in using an access point installed in a retail shop and the like. In other words, the user can enjoy the benefit of being able to connect to the Internet by answering a simple questionnaire, and thus, the user actively uses an access point installed in a retail shop and the like. In other words, use of an access point installed in a retail shop and the like is facilitated.

### Second Example Embodiment

Next, a second example embodiment will be described in detail with reference to the drawings.

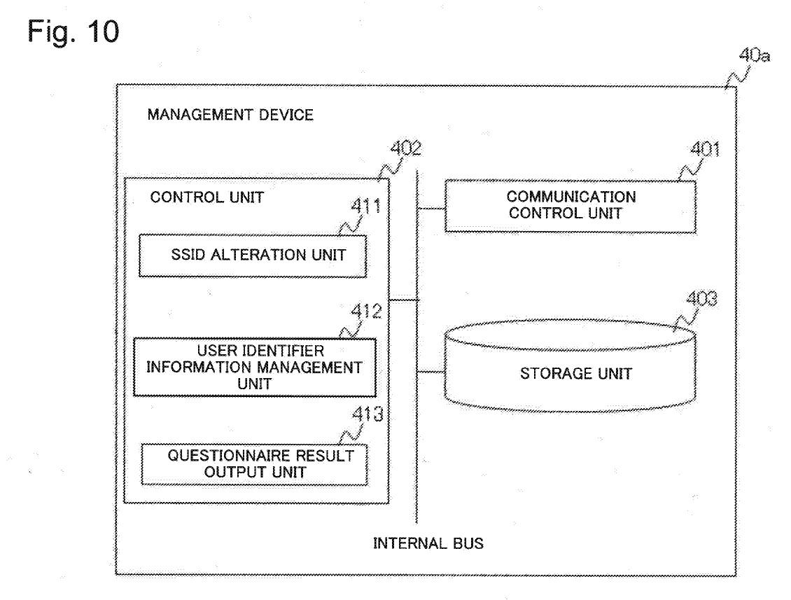

FIG. 10 is a diagram illustrating an example of an internal configuration of a management device 40a according to the second example embodiment. A difference between the management device 40 according to the first example embodiment and the management device 40a resides in that a control unit 402 includes a questionnaire result output unit 413.

The management device 40 according to the first example embodiment only acquires, from the aggregation device 20, user identifier information of a range designated from the management terminal 50, and outputs the acquired user identifier information to the management terminal 50. In other words, analysis of user identifier information is left up to a user (an owner of a retail shop and the like) side. The management device 40a according to the second example embodiment includes, in addition to the function of the management device 40, a function (the questionnaire result output unit 413) of executing information processing on user identifier information, and outputting a result thereof as a questionnaire result.

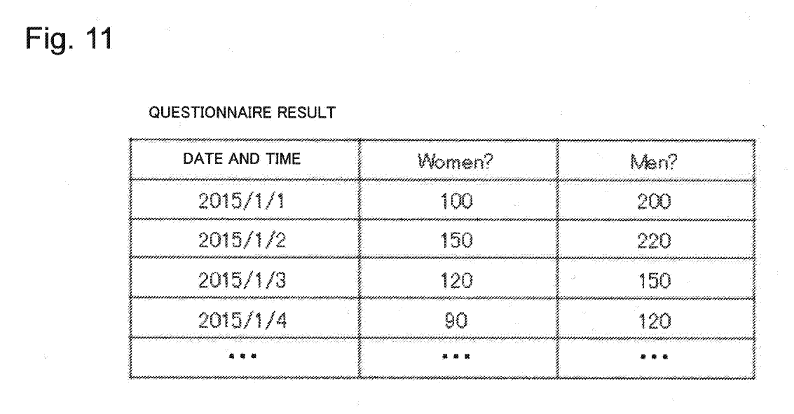

For example, the questionnaire result output unit 413 calculates, from user identifier information acquired by a user identifier information management unit 412, the number of connections using each SSID per day, and outputs a result thereof as a questionnaire result to a management terminal 50 (to a screen of the management terminal 50). For example, referring to FIG. 11, the number of wireless LAN connections made by using each of SSIDs “Women?” and “Men?” on Jan. 1, 2015 and thereafter is output as a questionnaire result to the management terminal 50. By confirming such a questionnaire result, an owner of a retail shop is able to easily grasp a fact (a tendency) that more men visit the own shop than women. As a result, the owner can consider a countermeasure such as expanding products for men.

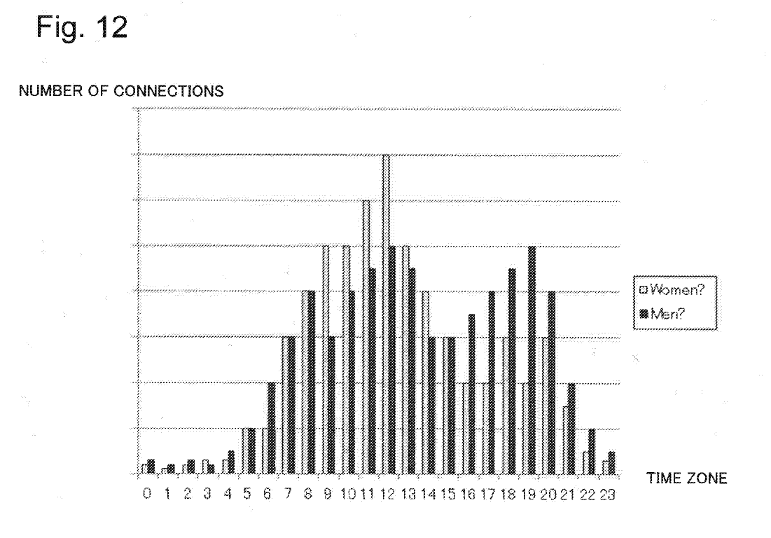

Alternatively, the questionnaire result output unit 413 may count the number of connections using each SSID per time zone, and may output a result of counting as a graph to the management terminal 50. For example, referring to FIG. 12, a graph (a questionnaire result) of the number of wireless LAN connections using each of SSIDs “Women?” and “Men?” per time zone in a day is output to the management terminal 50. By treating such a graph, an owner of a retail shop is able to easily grasp a visitor tendency per time zone. Specifically, it can be seen that a peak of the number of female visitors is present around noon, and that two peaks of the number of male visitors are present around noon and in the evening. The owner of the retail shop can utilize such a questionnaire result for management of the retail shop.

Note that the management device 40a is desirably configured to be able to input information relating to what kind of information processing (for example, counting of the number of SSID connections per day, and counting of SSIDs per time zone) is desired by a user (an owner of a retail shop). For example, the management device 40a may display a list of executable information processing on the management terminal 50, and the user may select information processing to be executed by the management device 40a. Alternatively, a file (an executable file, a batch file) describing processing to be executed by the management device 40a may be input to the management device 40a from the management terminal 50.

As above, the management device 40a according to the second example embodiment executes information processing on user identifier information acquired from an aggregation device 20, generates as a questionnaire result, and provides the result to a user (an owner of a retail shop and the like) via the management terminal 50. The user is able to easily acquire beneficial information without analyzing a result of a questionnaire using an SSID by himself/herself.

### Third Example Embodiment

Next, a third example embodiment will be described in detail with reference to the drawings.

In the first and second example embodiments, user identifier information generated by the aggregation device 20 has been described as being referred by an owner and the like of a retail shop in which the access point 10 is installed. However, a result of connection using an SSID (a questionnaire result) may be presented to a user of a terminal (a customer of the retail shop).

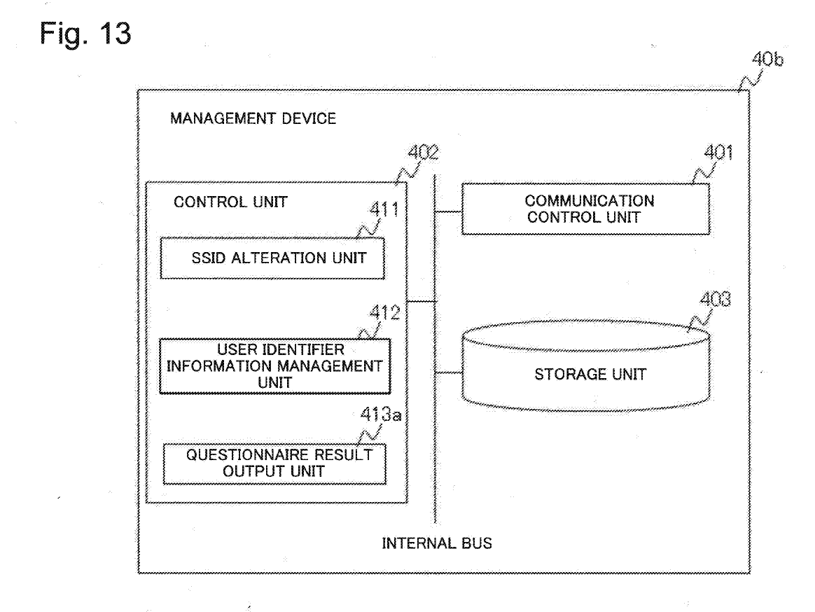

FIG. 13 is a diagram illustrating an example of an internal configuration of a management device 40b according to the third example embodiment. A difference between the management device 40b and the management device 40a according to the second example embodiment resides in that a function of a questionnaire result output unit 413a included in a control unit 402 is different.

The questionnaire result output unit 413a according to the third example embodiment periodically acquires user identifier information from an aggregation device 20. Thereafter, the questionnaire result output unit 413a generates a questionnaire result from the acquired user identifier information, and displays (outputs) a result thereof on a website (for example, a portal site provided by a web server 30) that can be confirmed from a terminal of a user and on a large display device installed in a shop.

For example, a case is considered in which a big sports event of a match played by two teams is held near a retail shop in which an access point 10-1 is installed, and an owner of the retail shop carries out a questionnaire relating to “Which team will win” by using an SSID.

In this case, the owner of the retail shop sets two types of SSIDs “Will Team A win?” and “Will Team B win?” in the access point 10-1. Access using the two SSIDs is accumulated in the aggregation device 20. The questionnaire result output unit 413a of the management device 40b periodically acquires an access log on the aggregation device 20, and calculates an accumulated value of connection using each SSID. Thereafter, the questionnaire result output unit 413a outputs a result of calculation to the web server 30 and a display device. In this way, a user who visits the retail shop is able to know defeat prediction of another user.

As above, the management device 40b according to the third example embodiment periodically acquires an access log stored in the aggregation device 20, and generates information (a questionnaire result) to be presented to a user from the acquired access log. The user is able to know a result of a questionnaire in which the user himself/herself participates, and thus, may be motivated to use the access point 10 installed by a retail shop and the like. In other words, use of an access point is further facilitated.

### Fourth Example Embodiment

Next, a fourth example embodiment will be described in detail with reference to the drawings.

In the first to third example embodiments, a mode in which the management device 40 manages and controls the access point 10 has been described. In the fourth example embodiment, a case in which the access point 10 includes the function of the management device 40 will be described.

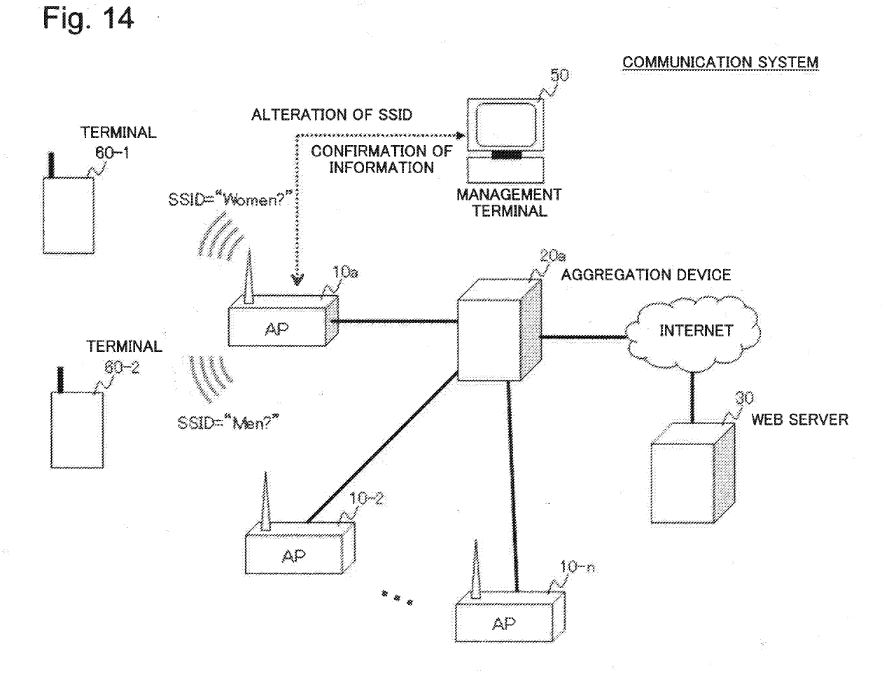

FIG. 14 is a diagram illustrating an example of a schematic configuration of a communication system according to the fourth example embodiment. A difference from the communication system (see FIG. 2) according to the first example embodiment resides in that the management device 40 is absent and that a partial function of the aggregation device 20 is implemented by the access point 10. In the fourth example embodiment, an instruction for alteration of an SSID is issued from a management terminal 50 directly to an access point 10a, and user identifier information is acquired from the access point 10a.

In the fourth example embodiment, the access point 10a does not transmit access information to an aggregation device 20a, but accumulates and stores access information within the access point 10a itself, thereby generating an access log described in the first example embodiment. The access point 10a also generates user identifier information and a questionnaire result by using the generated access log, and provides the management terminal 50 with the generated user identifier information and the questionnaire result.

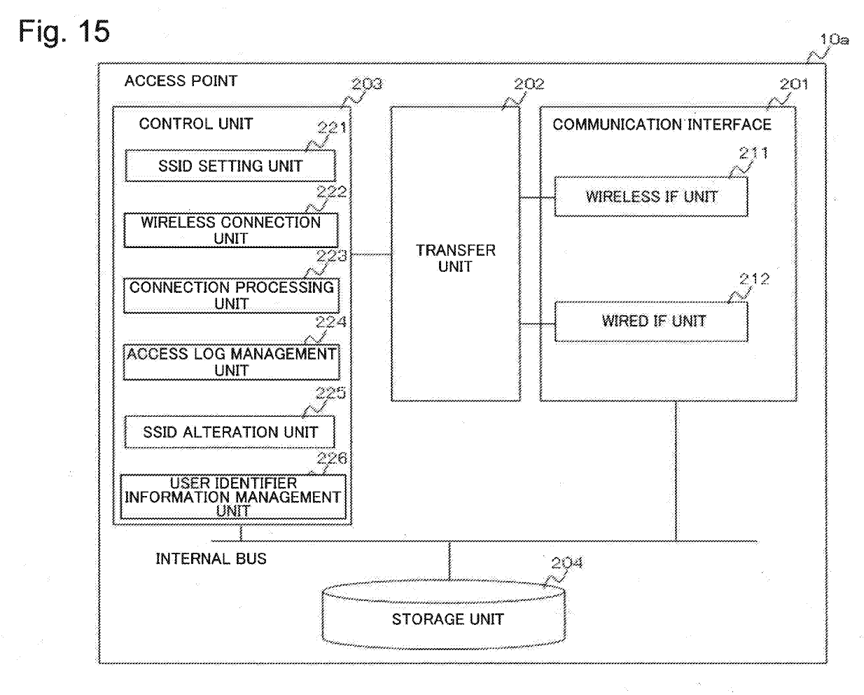

FIG. 15 is a diagram illustrating an example of an internal configuration of the access point 10a according to the fourth example embodiment. A difference between the access point 10 according to the first example embodiment and the access point 10a resides in that a control unit 203 includes an access log management unit 224, an SSID alteration unit 225, and a user identifier information management unit 226. Note that a function and an operation of the access log management unit 224 are substantially the same as those of the access log management unit 302 included in the aggregation device 20, and thus, description relating to the detail will be omitted. In addition, a function and an operation of the SSID alteration unit 225 are substantially the same as those of the SSID alteration unit 411 included in the management device 40, and thus, description relating to the detail will be omitted. Further, similarly, a function and an operation of the user identifier information management unit 226 are substantially the same as those of the user identifier information management unit 412, and thus, description thereof will be omitted.

The access point 10a receives, by using the SSID alteration unit 225, an SSID alteration instruction from a user (an owner of a retail shop and the like). The received alteration instruction is processed by an SSID setting unit 221, and a set SSID of a character string is broadcasted by a wireless interface unit 211. Thereafter, information (access information) relating to an SSID selected by a user of a wireless terminal is accumulated in a storage unit 204 and is managed as an access log. Thereafter, when the owner of the retail shop and the like instructs the access point 10a to output user identifier information, the user identifier information management unit 226 instructs the access log management unit 224 to generate user identifier information, and the access log management unit 224 extracts necessary access information. The user identifier information management unit 226 outputs the acquired user identifier information to the management terminal 50.

In other words, the access point 10a includes a means (a connection processing unit 223) that generates access information, based on access using an SSID by a wireless terminal. The access point 10a also includes a means (the access log management unit 224) that stores the generated access information and generates an access log. The access point 10a also includes a means (the SSID alteration unit 225) that receives, from an external terminal, data of a character string of an SSID to be broadcasted, and a means (the SSID setting unit 221) that alters, based on the character string, the SSID to be broadcasted. The access point 10a further includes a means (the user identifier information management unit 226) that generates user identifier information that includes the SSID used by the terminal connected to a wireless network, and outputs the user identifier information to outside.

As described above, a system that is completed by an access point and a management terminal can be constructed by including the function of the management device 40 in the access point 10a, and a compact and cost-reduced questionnaire system can be provided.

Note that an arbitrary combination of the above-described example embodiments is included as a further example embodiment. In addition, the configurations and the operations of the communication systems and the devices described in the first to fourth example embodiments are for illustrative purpose, and various modifications can be made.

For example, the communication system may include an access point not supporting multi-SSID. In addition, the access point 10 may be an access point supporting an SSID provided by a retail shop and the like and an SSID provided by a telecommunications carrier (the access point may be shared by a plurality of companies).

In the above-described example embodiment, the access point 10 has been described as including a dynamic host configuration protocol (DHCP) function of allocating an IP address to a terminal, but the DHCP function may be implemented in a device (for example, the aggregation device 20) other than the access point 10. Alternatively, the DHCP function may be implemented in a router not illustrated in FIG. 2.

The communication system may not include the web server 30. In other words, agreement with terms of use and the like may not be obtained before providing Internet connection to a wireless terminal.

In the above-described example embodiment, the questionnaire result output unit 413, 413a of the management device performs information processing with respect to user identifier information (analysis of user identifier information), but the aggregation device 20 may perform the information processing.

In the above-described example embodiment, it is premised that the management device 40 controls and manages the access point 10 included in the system, but a dedicated management device may be disposed in each access point 10.

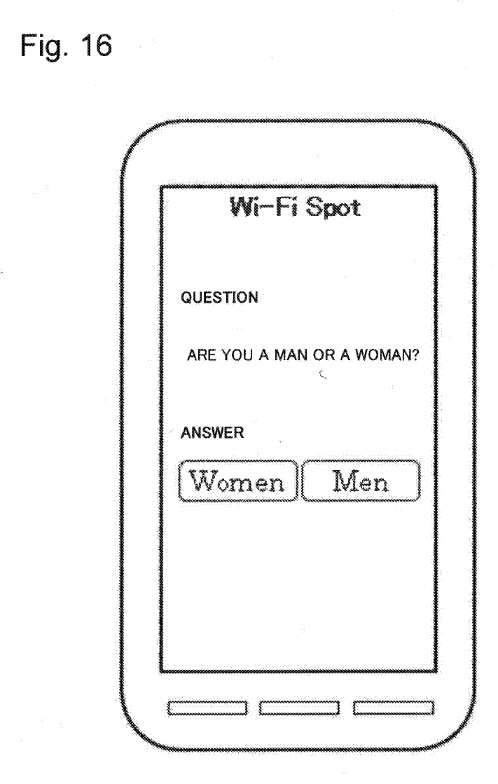

In the above-described example embodiment, a case in which a simple questionnaire system is constructed without introducing a novel application (software) to a terminal has been described. However, a system that is easier for a user to understand can be constructed by introducing (installing) an application supporting the above-described questionnaire system to a terminal. For example, it is conceivable that, before a user displays a Wi-Fi spot selection screen on a terminal, the terminal and the access point 10 exchanges information in advance, and a screen as illustrated in FIG. 16 is displayed as a Wi-Fi spot selection screen on the terminal. In FIG. 16, a question sentence (“Are you a man or a woman?”) describing a content of a questionnaire and answers (“Women”, “Men”) in response to the question are displayed, and a terminal transmits, to the access point 10, an answer selected by a user as an SSID to be used. In this way, a mode in which options are displayed with respect to a question sentence, and a mode in which, as described in the first example embodiment, a character string itself of an SSID is a question and a character string of an SSID affirmed by selection of a user is displayed are conceivable for realizing a questionnaire system.

An owner of a retail shop and the like may request the management device 40 to provide user identifier information over the plurality of access points 10. For example, in the communication system illustrated in FIG. 2, a case in which the access point 10-1 is installed in a retail shop A and the access point 10-2 is installed in a retail shop B is considered. Further, when the retail shop A and the retail shop B are run by an identical owner, the owner of the retail shops A and B may request the management device 40 to output user identifier information by designating an SSID to be broadcasted from the access points 10-1 and 10-2. In this case, since a plurality of SSIDs (a plurality of options) can be transmitted from a plurality of access points, more practical information can be acquired.

In the above-described example embodiment, the access point 10 broadcasts a character string input from the management device 40 with no change. However, the access point 10 may broadcast an input character string by altering the character string within a range not degrading identity of the input character string. For example, in the Wi-Fi spot selection screen illustrated in FIG. 9, when the SSID pertaining to “Men?” is always displayed higher than the SSID pertaining to “Women?”, selection of an SSID by a user may possibly be biased. Specifically, it is conceivable that even a female user may select “Men?” displayed higher in order. In view of this, the access point 10 (the SSID setting unit 221) may change the order of SSIDs displayed on a terminal, by assigning a numeral and the like to a head of an SSID acquired from the management device 40 and periodically changing the assigned numeral and the like. For example, the access point 10 may take a countermeasure such as broadcasting SSIDs including a set of “01Men?” and “02Women?” for a fixed period of time and thereafter broadcasting SSIDs including a set of “01Women?” and “02Men?”. In other words, the access point 10 may broadcast a character string (an SSID as an option for a questionnaire) input from the management device 40, by assigning a prefix to the character string and periodically changing a content of the prefix. When a terminal-side Wi-Fi spot screen employs a specification of displaying a character string of an SSID in character code order, the order of options (character strings of SSIDs) displayed on a terminal is changed depending on a time zone by taking the countermeasure described above, and user selection bias due to display order of SSIDs can be reduced.

Note that, when the access point 10 takes the above-described countermeasure pertaining to SSID alteration, the aggregation device 20 desirably generates user identifier information by taking a countermeasure such as treating pre-alteration and post-alteration SSIDs as being an identical SSID.

Control modules (a control unit and an access log management unit) of the respective devices (an access point, an aggregation device, and a management device) can be also implemented by a computer program that causes a computer equipped in the device to execute, by using hardware thereof, processing of the control unit and the like described above.

A part or all of the above-described example embodiments can be described as follows, but are not limited to the following.

### [Mode 1]

See the communication system according to the first aspect described above.

### [Mode 2]

The communication system according to Mode 1, wherein the management device designates a condition under which the aggregation device generates the user identifier information, and requests for output of the user identifier information.

### [Mode 3]

The communication system according to Mode 2, wherein the aggregation device extracts, from the access log, the access information that matches the condition provided from the management device, and outputs an extraction result as the user identifier information to the management device.

### [Mode 4]

The communication system according to any one of Modes 1 to 3, wherein the management device executes information processing with respect to the user identifier information acquired from the aggregation device, and outputs a result of the information processing to outside.

### [Mode 5]

The communication system according to Mode 4, wherein the management device outputs a result of the information processing to a web server or a display device.

### [Mode 6]

The communication system according to any one of Modes 1 to 5, further including a plurality of the access points, each of the plurality of access points being connected to the aggregation device, wherein

the aggregation device stores the access information output by each of the plurality of access points, and generates the access log.

### [Mode 7]

The communication system according to Mode 6, wherein the management device designates at least two or more access points among a plurality of the access points connected to the aggregation device, and requests the aggregation device to output the user identifier information that includes the identifier used by the terminal connected to a wireless network formed by the designated two or more access points.

### [Mode 8]

The communication system according to any one of Modes 1 to 7, wherein the access point alters a character string input from the management device, and broadcasts the altered character string.

### [Mode 9]

See the management device according to the second aspect described above.

### [Mode 10]

See the access point according to the third aspect described above.

### [Mode 11]

See the information collection method according to the fourth aspect described above.

### [Mode 12]

See the program according to the fifth aspect described above.

Note that Modes 9 to 12 can be expanded in a way similar to that in which Mode 1 is expanded to Modes 2 to 8.

Note that each disclosure of the above-described cited PTLs and the like is incorporated herein by reference. Modification and adjustment of each example embodiment or each example are possible within the scope of the overall disclosure (including the claims) of the present invention and based on the basic technical concept of the present invention. In addition, various combinations or selections of various disclosed elements (including elements in each claim, elements in each example embodiment or each example, elements in each drawing, and the like) are possible within the scope of the overall disclosure of the present invention. In other words, the present invention naturally includes various variations and modifications that could be made by those skilled in the art in accordance with the overall disclosure including the claims and the technical concept. In particular, with regard to ranges of numerical values described herein, arbitrary numerical values or sub-ranges included within the ranges should be interpreted as being specifically described even when not otherwise described.

### REFERENCE SIGNS LIST

10, 10-1 to 10-n, 10a, 11, 101 Access point
20, 20a, 21, 102 Aggregation device
30, 31 Web server
40, 40a, 40b, 103 Management device
50 Management terminal
60-1, 60-2, 61-1, 61-2 Terminal
71 Management server
201 Communication interface
202 Transfer unit
203, 402 Control unit
204, 303, 403 Storage unit
211 Wireless interface unit
212 Wired interface unit
221 SSID setting unit
222 Wireless connection unit
223 Connection processing unit
224, 302 Access log management unit
225, 411 SSID alteration unit
226, 412 User identifier information management unit
301, 401 Communication control unit
413, 413a Questionnaire result output unit

1-12. (canceled)

13. A management device that is connected with
an access point that broadcasts at least two or more identifiers for identifying at least two or more respective wireless networks, and outputs, as access information, an access by a terminal using the identifier, and
an aggregation device that stores the access information output by the access point, and generates an access log,
the management device
receiving data of a character string of the identifier to be broadcasted by the access point, and altering, based on the character string, the identifier to be broadcasted by the access point,
requesting the aggregation device to output user identifier information that includes the identifier used by the terminal connected to a wireless network formed by the access point, and
acquiring the user identifier information generated by the aggregation device from the access log, and outputting, to outside, information corresponding to the acquired user identifier information.

14. The communication system according to claim 13, wherein the management device designates a condition under which the aggregation device generates the user identifier information, and requests for output of the user identifier information.

15. The communication system according to claim 13, wherein the management device executes information processing with respect to the user identifier information acquired from the aggregation device, and outputs a result of the information processing to outside.

16. The communication system according to claim 15, wherein the management device outputs the result of the information processing to a web server or a display device.

17. An access point that broadcasts at least two or more identifiers for identifying at least two or more respective wireless networks, and generates, as access information, an access by a terminal using the identifier, the access point comprising:
a memory storing instructions; and
one or more processors configured to execute the instructions to:
store the generated access information, and generating an access log;
receive data of a character string of the identifier to be broadcasted, and altering, based on the input character string, the identifier to be broadcasted; and
generate user identifier information that includes the identifier used by the terminal connected to a wireless network formed by the access point, and outputting the user identifier information to outside.

18. An information collection method in a communication system that includes: an access point that broadcasts at least two or more identifiers for identifying at least two or more respective wireless networks, and outputs, as access information, an access by a terminal using the identifier; an aggregation device that stores the access information output by the access point, and generates an access log; and a management device that receives an input of a character string of the identifier to be broadcasted by the access point, and alters, based on the character string, the identifier to be broadcasted by the access point,
the information collection method comprising the steps of:
requesting, by the management device, the aggregation device to output user identifier information that includes the identifier used by the terminal connected to a wireless network formed by the access point;
generating, by the aggregation device, the user identifier information from the access log, and outputting the user identifier information to the management device; and
outputting, to outside, by the management device, information corresponding to the acquired user identifier information.
